(19) United States
(12) Patent Application Publication
(10) Pub. No.: US 2026/0314800 A1
(43) Pub. Date: Oct. 15, 2026

(54) APPLICATION CONTAINER

(71) Applicant: TOKIWA CORPORATION, Nakatsugawa-shi (JP)

(72) Inventor: Yukina KAWAGOE, Kawaguchi-shi (JP)

(21) Appl. No.: 19/573,196

(22) Filed: Mar. 20, 2026

(30) Foreign Application Priority Data
Apr. 9, 2025 (JP) 2025-064519
Apr. 24, 2025 (JP) 2025-072609

(51) Int. Cl. A45D 34/04

(52) U.S. Cl. CPC A45D 34/046

(57) ABSTRACT

An application container includes a cap configured to accommodate a liquid cosmetic therein, a container body to which the cap is attached, an application body being configured to come into contact with the liquid cosmetic accommodated inside the cap, in a case where the cap is attached to the container body, the application body attached to the container body, and a wiper into which the application body is inserted, in a case where the cap is attached to the container body, the wiper having a tubular shape, the wiper being attached to an inside of the cap.

### CROSS-REFERENCE TO RELATED APPLICATIONS

This application is based on and claims priority under 35 USC 119 from Japanese Patent Application No. 2025-064519 filed on April 9, 2025 and Japanese Patent Application No. 2025-072609 filed on April 24, 2025, the entire content of which is incorporated herein by reference.

### TECHNICAL FIELD

The present disclosure relates to an application container.

### BACKGROUND ART

JPH06-501871A describes an applicator assembly for a cosmetic composition. The applicator assembly includes a bottle that accommodates a product that is a liquid cosmetic, and a bottomed tubular cap that is attached to the bottle. The cap includes a shaft extending in an axial direction that is a direction in which an axis of the cap extends, and an application element located at a tip of the shaft.

The bottle includes a bottomed tubular case into which the application element is inserted. The case has an opening penetrating a side portion of the case, and the product enters the case from the opening. The product is accommodated inside the case. When the cap is attached to the bottle, the application element is inserted into the case. In a state in which the cap is attached to the bottle, an application body which is the application element is immersed in the product.

As described above, in the case in which the application body is immersed in the liquid cosmetic when the cap is attached to the bottle, a large amount of the liquid cosmetic may adhere to the application body when the cap is removed. When a large amount of the liquid cosmetic is attached to the application body, there is a problem that it is difficult to apply the liquid cosmetic evenly and to use the liquid cosmetic. Therefore, it is required to increase usability by attaching an appropriate amount of the liquid cosmetic to the application body.

### SUMMARY OF INVENTION

Aspect of non-limiting embodiments of the present disclosure relates to provide an application container capable of attaching an appropriate amount of a liquid cosmetic to an application body and improving usability.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an application container including:
a cap configured to accommodate a liquid cosmetic therein;
a container body to which the cap is attached;
an application body being configured to come into contact with the liquid cosmetic accommodated inside the cap, in a case where the cap is attached to the container body, the application body attached to the container body; and
a wiper into which the application body is inserted, in a case where the cap is attached to the container body, the wiper having a tubular shape, the wiper being attached to an inside of the cap,
in which the wiper has:
an opening that is located at an end of the wiper on a side opposite to the container body, and the opening penetrating the wiper in an axial direction in which an axis of the wiper extends, and
a through hole that penetrates a side surface of the wiper and allows the liquid cosmetic to flow from an outside of the wiper into an inside of the wiper.

### BRIEF DESCRIPTION OF DRAWINGS

Exemplary embodiment(s) of the present invention will be described in detail based on the following figures, wherein:

FIG. 1 is a side view showing an application container according to an embodiment;

FIG. 2 is a cross-sectional view taken along a line II-II in FIG. 1;

FIG. 3 is a cross-sectional view showing a wiper and a cap of the application container according to the embodiment;

FIG. 4 is a side view showing the wiper in FIG. 3;

FIG. 5 is a perspective view showing the wiper in FIG. 3;

FIG. 6 is a cross-sectional view showing a wiper and a cap of an application container according to a modification; and

FIG. 7 is a cross-sectional view showing a wiper and a cap of an application container according to a modification different from that in FIG. 6.

### DESCRIPTION OF EMBODIMENTS

Hereinafter, an embodiment of an application container according to the present disclosure will be described with reference to the drawings. In the description of the drawings, the same or corresponding elements are denoted by the same reference numerals, and redundant description will be appropriately omitted. For ease of understanding, some of the drawings may be illustrated in a simplified or exaggerated manner, and dimensional ratios and the like are not limited to those illustrated in the drawings.

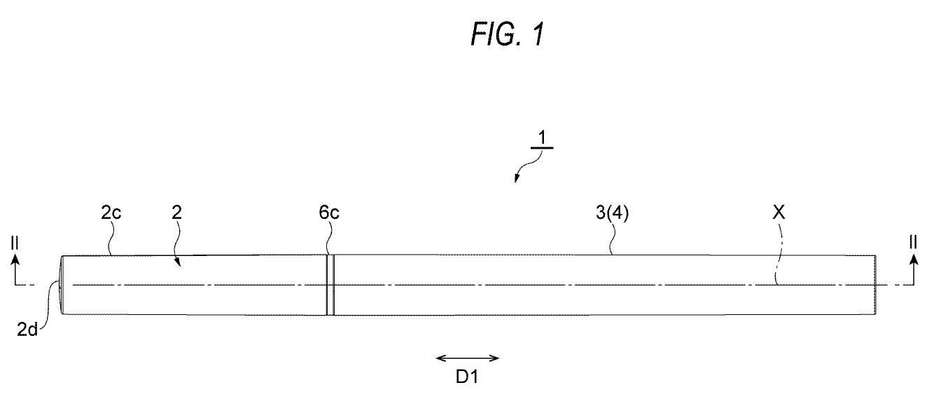

FIG. 1 is a side view showing an application container 1 according to the present embodiment. The application container 1 includes a cap 2 and a container body 3 to which the cap 2 is attached. The application container 1 has, for example, a rod shape. As an example, the application container 1 has a round rod shape. The cap 2 has a bottomed tubular shape.

In the application container 1, some components including the cap 2 have a tubular shape. For example, in the application container 1, an axis X of the cap 2 coincides with a direction in which axes of components other than the cap 2 extend. Hereinafter, a direction in which the axis X extends is referred to as an axial direction D1. In the present embodiment, the axial direction D1 coincides with a longitudinal direction of the application container 1. In the application container 1, the cap 2, and the container body 3 are arranged along the axial direction D1.

In the present embodiment, the cap 2 is attached to the container body 3 by rotating with respect to the container body 3. A direction in which each component of the application container 1 rotates about the axis X may be referred to as a circumferential direction or a rotation direction, and a direction orthogonal to the circumferential direction and the axial direction D1 may be referred to as a radial direction. In a plane orthogonal to the axial direction D1, a direction away from the axis X may be referred to as a radially outer side, and a direction approaching the axis X may be referred to as a radially inner side. However, these directions are for convenience of description, and do not limit arrangement positions or directions of the components.

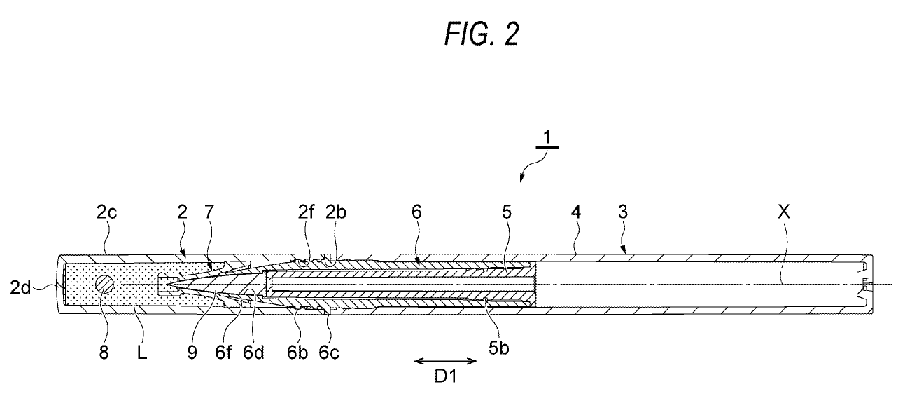

FIG. 2 is a cross-sectional view of the application container 1 when the application container 1 is cut along a plane including the axis X. As shown in FIGS. 1 and 2, the container body 3 includes, for example, a body tube 4 aligned with the cap 2 along the axial direction D1, a front tube 6 protruding from the body tube 4 into the cap 2, and a middle tube 5 located inside the front tube 6.

The cap 2 is attached to the container body 3 by being screwed to the container body 3. More specifically, the front tube 6 has a male screw 6b on an outer periphery, the cap 2 has a female screw 2f on an inner periphery, and the cap 2 is attached to the container body 3 by screwing the female screw 2f to the male screw 6b. A material for the front tube 6 is, for example, polypropylene (PP). However, the material for the front tube 6 may be a material other than PP, and is not particularly limited.

The cap 2 has an opening 2b into which the container body 3 (front tube 6) is inserted, a side surface portion 2c, and a bottom portion 2d. The cap 2 is configured to accommodate the liquid cosmetic L therein. In the present embodiment, a viscosity of the liquid cosmetic L is higher than a viscosity of an impregnation-type liquid cosmetic. For example, the viscosity of the impregnation-type liquid cosmetic is 5 Pa·s or more and 50 Pa·s or less, whereas the viscosity of the liquid cosmetic L is 50 Pa·s or more and 2200 Pa·s or less. The viscosity of the liquid cosmetic L may be 100 Pa·s or more. In the present embodiment, the liquid cosmetic L contains pearls.

The application container 1 includes a wiper 7 attached to an inside of the cap 2 and an application body 9 attached to the container body 3. In the present embodiment, the application body 9 is a brush. The wiper 7 has a tubular shape. As the cap 2 is attached to the container body 3, the application body 9 is inserted into the wiper 7. After the cap 2 is attached to the container body 3, for example, by shaking the application container 1, the application body 9 comes into contact with the liquid cosmetic L accommodated inside the cap 2. As the cap 2 is screwed to the container body 3, the application body 9 moves along the axial direction D1 inside the wiper 7.

The application container 1 includes a stirring member 8 located between the wiper 7 and the bottom portion 2d, inside the cap 2. The stirring member 8 is located inside the liquid cosmetic L. As the application container 1 is shaken, the stirring member 8 moves inside the liquid cosmetic L, so that the liquid cosmetic L is stirred. The stirring member 8 has, for example, a spherical shape. A material for the stirring member 8 is, for example, metal (for example, steel use stainless (SUS)).

The body tube 4 has a bottomed tubular shape. The front tube 6 includes a collar portion 6c located between the cap 2 and the container body 3 in a case where the cap 2 is attached to the container body 3, and a tapered portion 6f protruding from the collar portion 6c to a side opposite to the body tube 4. For example, an outer diameter of the tapered portion 6f decreases as a distance from the collar portion 6c increases. The tapered portion 6f has a tubular shape, and the application body 9 is held in an inside 6d of the tapered portion 6f.

The middle tube 5 extends in the axial direction D1 in the inside 6d of the front tube 6. The middle tube 5 has, for example, an annular recess 5b recessed on an outer periphery of the middle tube 5. For example, the application container 1 includes an O-ring (not shown) fitted into the annular recess 5b and in close contact with an inner surface of the front tube 6. In this case, the liquid cosmetic L can be more reliably prevented from leaking from between the middle tube 5 and the front tube 6.

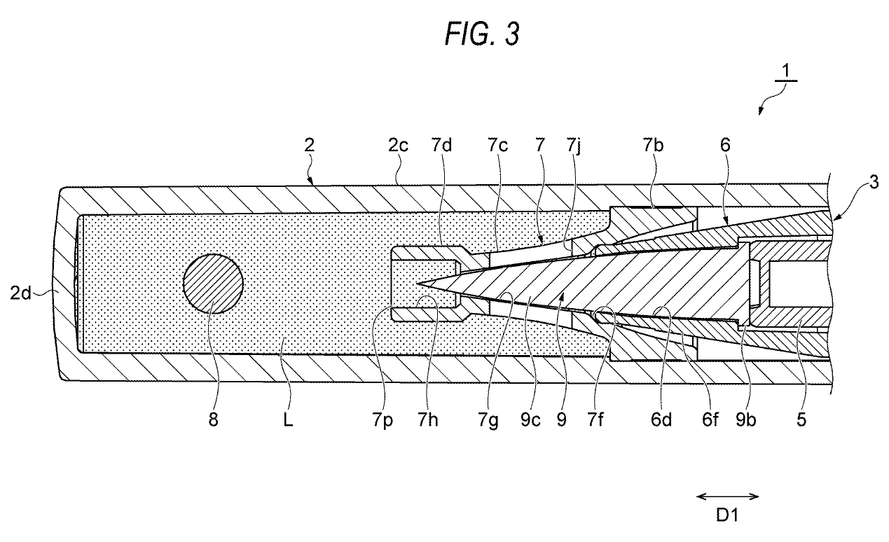

Next, the wiper 7 and a configuration around the wiper 7 will be described in detail with reference to FIG. 3. As shown in FIG. 3, the application body 9 includes a brush holder 9b sandwiched between the front tube 6 and the middle tube 5, and a brush portion 9c extending from the brush holder 9b into the wiper 7. The brush portion 9c is a portion in which a plurality of bristles constituting the application body 9 are bundled. A thickness of the brush portion 9c decreases as a distance from the brush holder 9b increases.

The wiper 7 has a function of preventing leakage of the liquid cosmetic L inside the cap 2. The wiper 7 is made of, for example, a soft resin that can prevent the leakage of the liquid cosmetic L. As an example, a material for the wiper 7 is polypropylene (PP). However, the material for the wiper 7 may be polyethylene (PE), and is not particularly limited as long as the leakage of the liquid cosmetic L can be prevented.

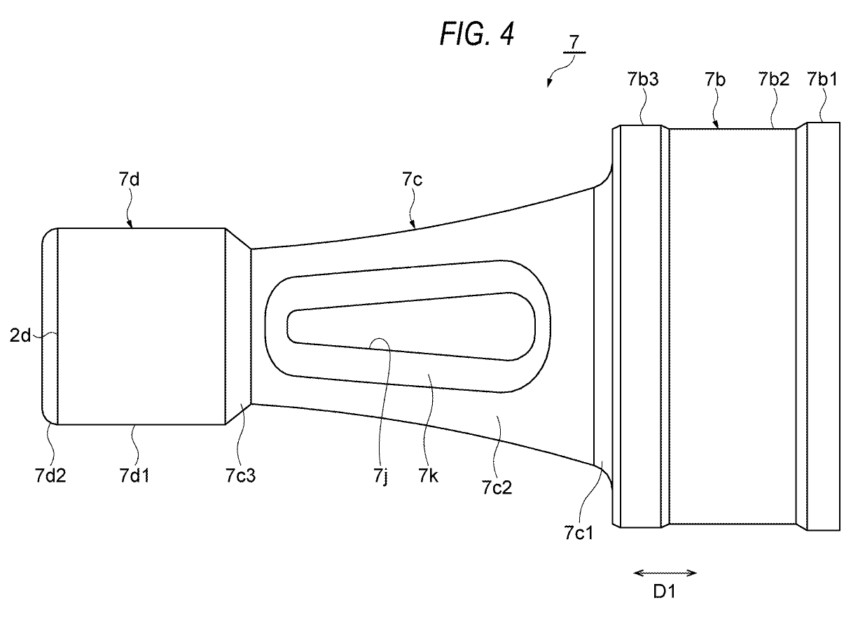

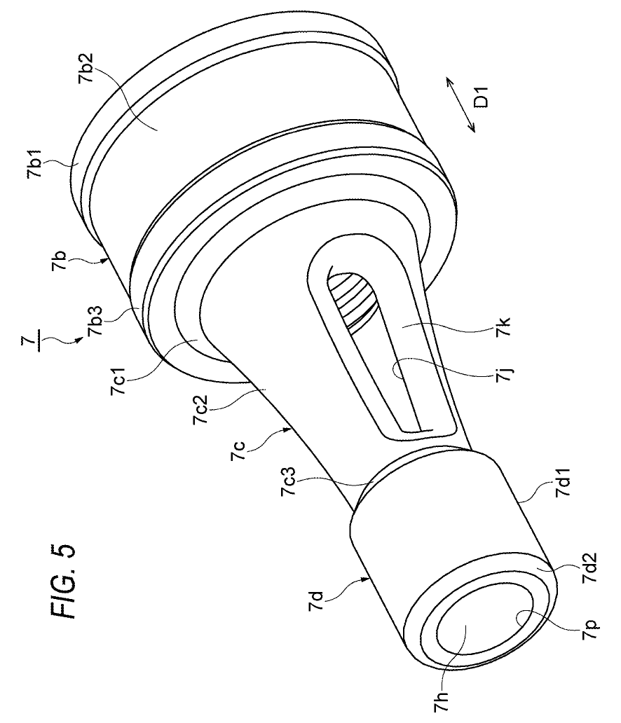

FIG. 4 is a side view showing the wiper 7. FIG. 5 is a perspective view showing the wiper 7. As shown in FIGS. 3, 4, and 5, the wiper 7 has an opening 7p located at an end of the wiper 7 on a side opposite to the container body 3. As an example, the opening 7p has a circular shape. The opening 7p penetrates the wiper 7 in the axial direction D1. The liquid cosmetic L flows through the opening 7p. For example, the liquid cosmetic L is supplied from the opening 7p to the application body 9 located inside the wiper 7, and the liquid cosmetic L remaining inside the wiper 7 without being absorbed in the application body 9 is discharged.

The wiper 7 includes a fixed portion 7b that is a portion fixed to an inner surface of the cap 2, and a liquid flow portion 7c extending from the fixed portion 7b toward the opening 7p. The wiper 7 may include a tubular portion 7d extending from the liquid flow portion 7c to the opening 7p. For example, a thickness of the liquid flow portion 7c decreases towards the opening 7p. For example, a cross section of the liquid flow portion 7c cut by a plane orthogonal to the axial direction D1 has an annular shape. In this case, an outer diameter of the liquid flow portion 7c decreases as approaching the opening 7p.

The wiper 7 is fixed inside the cap 2 by being press-fitted into the cap 2. At this time, a part of an outer peripheral surface of the fixed portion 7b tightly abuts against and adheres to the inner surface of the cap 2. The fixed portion 7b adheres to the inner surface of the cap 2, thereby preventing the leakage of the liquid cosmetic L from the cap 2.

The fixed portion 7b has, for example, a tubular shape. A minimum value of an outer diameter of the fixed portion 7b is larger than a maximum value of the outer diameter of the liquid flow portion 7c. The fixed portion 7b has a first annular convex 7b1 located at an end of the wiper 7 on a side opposite to the opening 7p, a second annular convex 7b3 located at a boundary with the liquid flow portion 7c of the fixed portion 7b, and an annular recess 7b2 located between the first annular convex 7b1 and the second annular convex 7b3. The fixed portion 7b is fixed to the inner surface of the cap 2 by causing the first annular convex 7b1 and the second annular convex 7b3 to adhere to the inner surface of the cap 2.

The liquid flow portion 7c includes, for example, a curved surface 7c1 located at the boundary with the fixed portion 7b, an inclined surface 7c2 extending from the curved surface 7c1 toward the tubular portion 7d, and a tapered surface 7c3 located at a boundary with the tubular portion 7d. The curved surface 7c1 is curved in a manner of being recessed as a distance from the fixed portion 7b increases. For example, the inclined surface 7c2 is curved in a manner of being recessed as a distance from the curved surface 7c1 increases in a side view. However, the inclined surface 7c2 may extend linearly in a side view. The tapered surface 7c3 is a portion where a diameter of the liquid flow portion 7c increases as approaching the tubular portion 7d.

The tubular portion 7d has, for example, a cylindrical shape. The tubular portion 7d has a larger diameter than the liquid flow portion 7c. For example, the tubular portion 7d includes an enlarged diameter portion 7d1 which is a portion enlarged in diameter with respect to the liquid flow portion 7c, and a curved surface 7d2 located between the enlarged diameter portion 7d1 and the opening 7p. An outer diameter of the curved surface 7d2 decreases as approaching the opening 7p.

The wiper 7 has a through hole 7j penetrating a side surface of the wiper 7. The through hole 7j is formed in the liquid flow portion 7c. For example, the wiper 7 has an inclined surface 7k that is inclined in a manner of being recessed from an outer peripheral surface of the liquid flow portion 7c and extends in an annular shape such that the liquid cosmetic L more easily flows in. The through hole 7j is formed inside the inclined surface 7k.

The wiper 7 has, for example, a plurality of through holes 7j. The plurality of through holes 7j are arranged along the radial direction. In the through hole 7j, the liquid cosmetic L can flow from an outside of the wiper 7 into an inside of the wiper 7. The through hole 7j has, for example, a rounded trapezoidal shape. A length of the through hole 7j in an axial direction D1 is longer than a length of the through hole 7j in the circumferential direction. The length of the through hole 7j in the circumferential direction decreases as approaching the opening 7p.

An example of lengths of the wiper 7 and the through hole 7j will be described. For example, the length of the wiper 7 in the axial direction D1 is 15 mm or more and 16 mm or less (for example, 15.45 mm). The length of the through hole 7j in the axial direction D1 is 3.0 mm or more and 4.8 mm or less. When the through hole 7j has a rounded trapezoidal shape as described above, a length of an upper bottom portion of the through hole 7j is 0.6 mm or more and 1.0 mm or less, and a length of a lower bottom portion of the through hole 7j is 1.0 mm or more and 1.4 mm or less. When the lengths of the wiper 7 and the through hole 7j satisfy the above example, an appropriate amount of the liquid cosmetic L can be supplied by the application body 9 located inside the wiper 7. However, the lengths of the wiper 7 and the through hole 7j are not limited to the above example.

An inner surface of the wiper 7 includes an abutting portion 7f on which a tip of the front tube 6 inserted into the cap 2 abuts, a similar shape portion 7g extending from the abutting portion 7f toward the opening 7p and along an outer surface of the application body 9, and a non-similar shape portion 7h located on a side of the similar shape portion 7g opposite to the container body 3. The abutting portion 7f is an annular recess recessed in the inner surface of the wiper 7.

The similar shape portion 7g is formed inside the liquid flow portion 7c. The through hole 7j is formed in the similar shape portion 7g. The similar shape portion 7g is a portion extending along an outer surface of the application body 9 inserted into the wiper 7. An inner diameter of the similar shape portion 7g decreases as approaching the opening 7p. For example, the similar shape portion 7g extends substantially parallel to the outer surface of the application body 9. Accordingly, the appropriate amount of the liquid cosmetic L can be supplied to the application body 9, the application body 9 can be smoothly inserted into the wiper 7, the brush portion 9c can be prevented from coming apart, and the brush spread after a use can be arranged. For example, a length of the similar shape portion 7g in the axial direction D1 may be 50% or more of a length of the application body 9 in the axial direction D1.

The application body 9 inserted into the wiper 7 does not protrude from the opening 7p and is located closer to the container body 3 than the opening 7p. That is, the application body 9 inserted into the wiper 7 is submerged in the opening 7p. For example, a tip of the application body 9 inserted into the wiper 7 is located inside the tubular portion 7d and faces the non-similar shape portion 7h.

The non-similar shape portion 7h is located inside the tubular portion 7d. The non-similar shape portion 7h is a portion of the inner surface of the wiper 7 which is not similar to a shape of the outer surface of the application body 9. The non-similar shape portion 7h forms a space with the outer surface of the application body 9 inserted into the wiper 7. A distance from the non-similar shape portion 7h to the outer surface of application body 9 increases towards the opening 7p.

Next, operations and effects obtained from the application container 1 according to the present embodiment will be described. In the application container 1, the cap 2 accommodating the liquid cosmetic L is attached to the container body 3, and the application body 9 is attached to the container body 3. After the cap 2 is attached to the container body 3, for example, by shaking the application container 1 after the cap 2 is attached to the container body 3, the application body 9 comes into contact with the liquid cosmetic L accommodated inside the cap 2. The tubular wiper 7 is attached inside the cap 2. The application body 9 is inserted into the wiper 7 when the cap 2 is attached to the container body 3. The wiper 7 has the opening 7p penetrating the wiper 7 in the axial direction D1 and located at the end of the wiper 7 on the side opposite to the container body 3, and the through hole 7j penetrating the side surface of the wiper 7. The liquid cosmetic L can flow from an outside of the wiper 7 into an inside of the wiper 7 via the opening 7p and the through hole 7j.

Accordingly, since the liquid cosmetic L can be circulated through the opening 7p and the through hole 7j after the cap 2 is attached to the container body 3 and when the cap 2 is removed from the container body 3, the appropriate amount of the liquid cosmetic L can be attached to the application body 9. For example, when the cap 2 is removed from the container body 3, the liquid cosmetic L can flow from the outer surface of the application body 9 to the outside of the wiper 7 via the through hole 7j, and thus it is possible to prevent a large amount of the liquid cosmetic L from adhering to the application body 9. Therefore, the appropriate amount of the liquid cosmetic L can be attached to the application body 9, and usability can be improved. By shaking the application container 1 during the use, the liquid cosmetic L can flow into the wiper 7 from the through hole 7j of the wiper 7, and the application body 9 can be impregnated with the liquid cosmetic L.

In the present embodiment, the inner surface of the wiper 7 includes the similar shape portion 7g extending along the outer surface of the application body 9. The through hole 7j is formed in the similar shape portion 7g. In this case, when the cap 2 is attached and when the cap 2 is detached, the outer surface of the application body 9 moves along the similar shape portion 7g, so that the appropriate amount of the liquid cosmetic L can be attached to the outer surface of the application body 9. Since it is possible to prevent expansion of the application body 9 due to excessive absorption of the liquid cosmetic L, it is possible to further improve the usability. Further, since the similar shape portion 7g extends along an outer surface of the brush portion 9c, it is possible to prevent the brush portion 9c from coming apart when the application body 9 is inserted into the wiper 7, and to arrange the expanded brush after the use. Since the expansion of the application body 9 in the similar shape portion 7g can be prevented, only the appropriate amount of the liquid cosmetic L can be absorbed in the application body 9. When the cap 2 is attached to the container body 3, the outer surface of the application body 9 can be arranged along the similar shape portion 7g.

In the present embodiment, the inner surface of the wiper 7 includes the non-similar shape portion 7h that is located on the side opposite to the container body 3 across the similar shape portion 7g and forms the space with the outer surface of the application body 9 inserted into the wiper 7. The distance from the non-similar shape portion 7h to the outer surface of application body 9 increases as approaching the opening 7p. In this case, the non-similar shape portion 7h is located on the side opposite to the container body 3 when viewed from the similar shape portion 7g, and for the non-similar shape portion 7h, the distance of the space from the outer surface of the application body 9 increases as approaching the opening 7p. Therefore, the application body 9 can be smoothly inserted into the wiper 7, and the application body 9 can be prevented from coming apart. For example, an inner diameter of the non-similar shape portion 7h is 150% or less of an outer diameter of the application body 9 not containing the liquid cosmetic L. In this case, it is possible to prevent the application body 9 from expanding and coming apart while providing an appropriate gap between the outer surface of the application body 9 and the non-similar shape portion 7h.

In the present embodiment, the wiper 7 includes the tubular portion 7d, the tubular portion 7d includes the enlarged diameter portion 7d1 in which the diameter is enlarged with respect to the liquid flow portion 7c, and an internal space of the non-similar shape portion 7h is enlarged with respect to an internal space of the similar shape portion 7g. Accordingly, since the opening 7p is enlarged, a periphery of the opening 7p is prevented from being clogged with the liquid cosmetic L, so that bending of the application body 9 can be avoided. Therefore, even when the viscosity of the liquid cosmetic L is high and the liquid cosmetic L contains the pearls, the application container 1 can be used without problems, and thus the usability of the application container 1 can be further improved.

In the present embodiment, the cap 2 is attached to the container body 3 by being screwed to the container body 3. When the cap 2 is screwed to the container body 3, the application body 9 moves along the axial direction D1 inside the wiper 7. In this case, the application body 9 can be reliably moved in the axial direction D1 as the cap 2 is screwed to the container body 3. That is, it is possible to prevent the application body 9 from moving in a direction inclined with respect to the axial direction D1. Therefore, it is possible to prevent the application body 9 from abutting against the inner surface of the wiper 7 and coming apart.

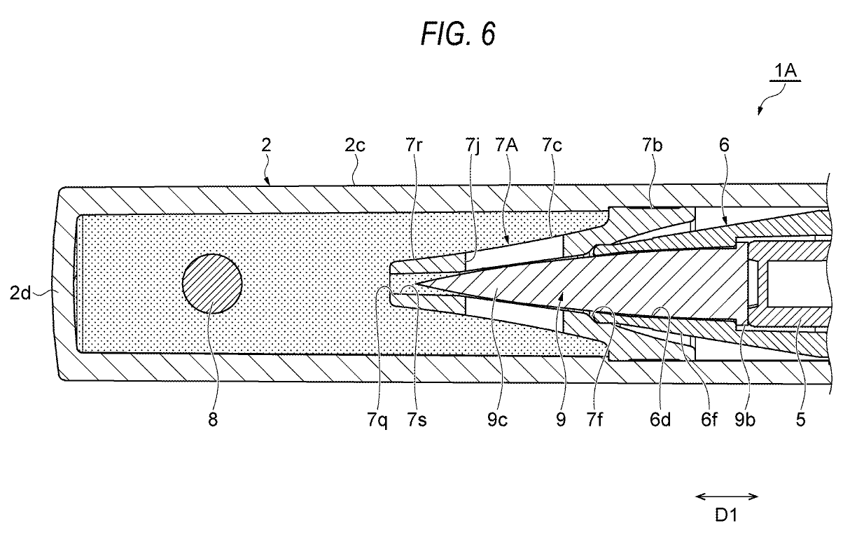

Next, an application container according to a modification will be described. A configuration of a part of the application container according to a modification to be described later is the same as the configuration of the part of the application container 1 described above. Accordingly, in the following, the same components as those already described are denoted by the same reference numerals and description thereof will be appropriately omitted. FIG. 6 is a cross-sectional view showing a periphery of a wiper 7A of an application container 1A according to the modification.

A wiper 7A has a tubular portion 7r having a shape different from that of the tubular portion 7d described above. The tubular portion 7r extends along the axial direction D1 from an end of the liquid flow portion 7c. The wiper 7A has a non-similar shape portion 7s located inside the tubular portion 7r. The non-similar shape portion 7s extends along the axial direction D1 from an end of the similar shape portion 7g. An opening 7q is formed at an end of the non-similar shape portion 7s on a side opposite to the similar shape portion 7g.

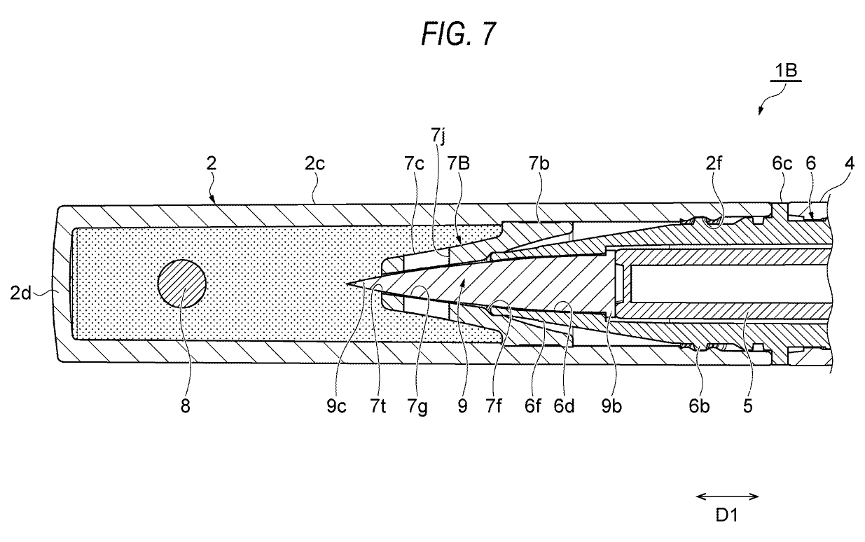

FIG. 7 is a cross-sectional view showing a periphery of a wiper 7B of an application container 1B according to a modification different from FIG. 6. The wiper 7B is different from the wiper 7 described above in that the non-similar shape portion 7h is not provided. In the wiper 7B, an opening 7t is formed at an end of the similar shape portion 7g on a side opposite to the container body 3, and the application body 9 can protrude from the opening 7t. The amount of protrusion of the application body 9 from the opening 7t is, for example, 2 mm.

The embodiments and various modifications of the application container according to the present disclosure have been described above. However, the application container according to the present disclosure is not limited to the contents of each of the above-described embodiments and modifications, and may be further modified within the scope of the gist described in the claims. That is, a shape, size, material, number, and arrangement form of each component of the application container according to the present disclosure can be appropriately changed within the scope of the gist described above.

For example, in the above-described embodiment, the application container 1 in which the cap 2 is screwed to the container body 3 has been described. However, the application container may include a cap that is not screwed to the container body. For example, the container body may have a protrusion on an outer surface, the cap may have a recess on an inner surface, and the cap may be attached to the container body by fitting the protrusion into the recess. In this way, the configuration for attaching the cap to the container body is not particularly limited.

In the above-described embodiment, the container body 3 including the body tube 4, the middle tube 5, and the front tube 6 has been described. However, types and the number of components constituting the container body can be appropriately changed. In the above-described embodiment, the application body 9 which is the brush has been described. However, the application body may be other than the brush. For example, the application body may be a chip formed by solidifying bundled fibers. In this way, a type of the application body can be appropriately changed.

(1) An application container according to the present disclosure includes:
a cap configured to accommodate a liquid cosmetic therein;
a container body to which the cap is attached;
an application body being configured to come into contact with the liquid cosmetic accommodated inside the cap, in a case where the cap is attached to the container body, the application body attached to the container body; and
a wiper into which the application body is inserted, in a case where the cap is attached to the container body, the wiper having a tubular shape, the wiper being attached to an inside of the cap, in which the wiper has:
an opening that is located at an end of the wiper on a side opposite to the container body, and the opening penetrating the wiper in an axial direction in which an axis of the wiper extends, and
a through hole that penetrates a side surface of the wiper and allows the liquid cosmetic to flow from an outside of the wiper into an inside of the wiper.

In this application container, the cap that accommodates the liquid cosmetic is attached to the container body, and the application body is attached to the container body. The application body comes into contact with the liquid cosmetic accommodated inside the cap when the cap is attached to the container body. The tubular wiper is attached to the inside of the cap. The application body is inserted into the wiper when the cap is attached to the container body. The wiper has the opening penetrating the wiper in the axial direction and located at the end of the wiper on the side opposite to the container body, and the through hole penetrating the side surface of the wiper. The liquid cosmetic can flow from the outside of the wiper to the inside of the wiper via the opening and the through hole. Accordingly, since the liquid cosmetic can be circulated through the opening and the through hole after the cap is attached to the container body and when the cap is removed from the container body, an appropriate amount of the liquid cosmetic can be attached to the application body. For example, when the cap is removed from the container body, the liquid cosmetic can flow from the outer surface of the application body to the outside of the wiper via the through hole, and thus it is possible to prevent a large amount of the liquid cosmetic from adhering to the application body. Therefore, the appropriate amount of the liquid cosmetic can be attached to the application body, and usability can be improved.

(2) The application container according to (1), in which an inner surface of the wiper includes a similar shape portion extending along an outer surface of the application body, and the through hole is formed in the similar shape portion. In this case, when the cap is attached and when the cap is detached, the outer surface of the application body moves along the similar shape portion, so that the appropriate amount of the liquid cosmetic can be attached to the outer surface of the application body. Further, it is possible to prevent expansion of the application body due to excessive absorption of the liquid cosmetic, so that it is possible to further improve the usability.

(3) The application container according to (2), in which the inner surface of the wiper includes a non-similar shape portion that is located on a side opposite to the container body across the similar shape portion and that forms a space with the outer surface of the application body inserted into the wiper, and a distance from the non-similar shape portion to the outer surface of the application body increases towards the opening. In this case, the non-similar shape portion is located on the side opposite to the container body when viewed from the similar shape portion, and for the non-similar shape portion, a distance of a space from the outer surface of the application body increases as approaching the opening. Therefore, the application body can be smoothly inserted into the wiper, and the application body can be prevented from coming apart.

(4) The application container according to any one of (1) to (3), in which the cap is configured to be attached to the container body by being screwed to the container body, and as the cap is screwed to the container body, the application body moves along the axial direction inside the wiper. In this case, the application body can be reliably moved in the axial direction as the cap is screwed to the container body. That is, it is possible to prevent the application body from moving in a direction inclined with respect to the axial direction. Therefore, it is possible to prevent the application body from abutting against the inner surface of the wiper and coming apart.

(5) The application container according to claim (2), in which the opening is formed at an end of the similar shape portion on the side opposite to the container body, and the application body is configured to protrude from the opening.

According to the present disclosure, an appropriate amount of a liquid cosmetic can be attached to an application body, and usability can be improved.

What is claimed is:

1. An application container comprising:
a cap configured to accommodate a liquid cosmetic therein;
a container body to which the cap is attached;
an application body being configured to come into contact with the liquid cosmetic accommodated inside the cap, in a case where the cap is attached to the container body, the application body attached to the container body; and
a wiper into which the application body is inserted, in a case where the cap is attached to the container body, the wiper having a tubular shape, the wiper being attached to an inside of the cap,
wherein the wiper has:
an opening that is located at an end of the wiper on a side opposite to the container body, and the opening penetrating the wiper in an axial direction in which an axis of the wiper extends, and
a through hole that penetrates a side surface of the wiper and allows the liquid cosmetic to flow from an outside of the wiper into an inside of the wiper.

2. The application container according to claim 1,
wherein an inner surface of the wiper includes a similar shape portion extending along an outer surface of the application body, and
the through hole is formed in the similar shape portion.

3. The application container according to claim 2,
wherein the inner surface of the wiper includes a non-similar shape portion that is located on a side opposite to the container body across the similar shape portion and that forms a space with the outer surface of the application body inserted into the wiper, and
a distance from the non-similar shape portion to the outer surface of the application body increases towards the opening.

4. The application container according to claim 1,
wherein the cap is configured to be attached to the container body by being screwed to the container body, and
as the cap is screwed to the container body, the application body moves along the axial direction inside the wiper.

5. The application container according to claim 2,
wherein the opening is formed at an end of the similar shape portion on the side opposite to the container body, and the application body is configured to protrude from the opening.
